(19) United States
(12) Patent Application Publication
(10) Pub. No.: US 2026/0319257 A1
(43) Pub. Date: Oct. 15, 2026

(54) OPTICAL SYSTEM AND DISPLAY APPARATUS

(71) Applicants: Beijing Zitiao Network Technology Co., Ltd., Beijing (CN); Lemon Inc., Grand Cayman (KY)

(72) Inventors: Ling FU, Beijing (CN); Xin LI, Beijing (CN); Ziyang ZHANG, Los Angeles, CA (US); Shaopeng ZHU, Beijing (CN); Hsin-Yi HU, Beijing (CN)

(21) Appl. No.: 19/484,318

(22) PCT Filed: Aug. 7, 2024
(86) PCT No.: PCT/CN2024/110437

§ 371 Date: Nov. 13, 2025

(30) Foreign Application Priority Data
Aug. 10, 2023 (CN) 202311006667.8

(51) Int. Cl. G02B 27/01; G02B 5/30

(52) U.S. Cl. CPC G02B 27/0172; G02B 5/3083

(57) ABSTRACT

The embodiment of the present disclosure provides an optical system and a display apparatus. The optical system includes: a lens structure, includes a convex surface and a concave surface that are oppositely arranged; a reflective polarizing laver, disposed on the side of the concave surface of the lens structure away from the convex surface of the lens structure; a phase retardation film, disposed on the side of the concave surface of the lens structure away from the convex surface of the lens structure; and a transflective film, disposed on a side of the convex surface away from the concave surface.

The present application claims priority of Chinese Patent Application No. 202311006667.8, filed on Aug. 10, 2023, which is incorporated herein by reference in its entirety as a part of the present application.

### TECHNICAL FIELD

At least one embodiment of the present disclosure relates to an optical system and a display apparatus.

### BACKGROUND

Virtual reality (Virtual Reality, VR) technology is a computer simulation technology that can create and experience a virtual world. It uses a computer to generate an interactive three-dimensional dynamic view, allowing users to immerse in the environment. To improve user experience, products applying virtual reality technology are developing in a lighter and thinner direction.

### SUMMARY

At least one embodiment of the present disclosure provides an optical system, including: a lens structure, including a convex surface and a concave surface that are oppositely arranged, and a side of the concave surface away from the convex surface is a light exit side of the lens structure; a reflective polarizing layer, disposed on the side of the concave surface of the lens structure away from the convex surface of the lens structure; a phase retardation film, disposed on the side of the concave surface of the lens structure away from the convex surface of the lens structure; and a transflective film, disposed on a side of the convex surface away from the concave surface; where a ratio of a radius of curvature of the convex surface to an effective focal length of the optical system is −1.2 to −2.5, and a ratio of a radius of curvature of the concave surface to the radius of curvature of the convex surface is 0.8 to 2; and in a direction parallel to an optical axis of the lens structure, a ratio of a center thickness of the lens structure to the effective focal length is 0.4 to 0.6.

For example, according to an embodiment of the present disclosure, an absolute value of a conic coefficient of the convex surface is less than or equal to an absolute value of a conic coefficient of the concave surface.

For example, according to an embodiment of the present disclosure, the conic coefficient of the convex surface is greater than or equal to −20 and less than 0, and the conic coefficient of the concave surface is greater than or equal to −50 and less than or equal to the conic coefficient of the convex surface.

For example, according to an embodiment of the present disclosure, at least one of the convex surface or the concave surface is an aspheric surface or a free-form surface.

For example, according to an embodiment of the present disclosure, a ratio of an optical total length of the optical system to the effective focal length is 0.8 to 1.2.

For example, according to an embodiment of the present disclosure, a ratio of an effective aperture of the lens structure to the effective focal length is greater than or equal to 2.

For example, according to an embodiment of the present disclosure, an eye relief of the optical system is 12 to 18 millimeters.

For example, according to an embodiment of the present disclosure, a field of view of the optical system is 900 to 110°.

For example, according to an embodiment of the present disclosure, the lens structure is an integral lens, and the convex surface and the concave surface are located on opposite sides of the integral lens.

For example, according to an embodiment of the present disclosure, the reflective polarizing layer is configured to reflect linearly polarized light of one characteristic and transmit linearly polarized light of another characteristic; the phase retardation film is disposed on the side of the concave surface away from the convex surface, and the reflective polarizing layer is disposed on a side of the phase retardation film away from the convex surface; or the reflective polarizing layer is a cholesteric liquid crystal layer; and the cholesteric liquid crystal layer is disposed on the side of the concave surface away from the convex surface, and the phase retardation film is disposed on a side of the cholesteric liquid crystal layer away from the convex surface.

For example, according to an embodiment of the present disclosure, the optical system further includes a linear polarizing film; and the linear polarizing film is disposed on a side of the reflective polarizing layer away from the transflective film.

For example, according to an embodiment of the present disclosure, the lens structure includes a first lens and a second lens; the first lens has a first surface and a second surface that are oppositely arranged, the first surface is the convex surface of the lens structure, and the second surface is a flat surface; and the second lens has a third surface and a fourth surface that are oppositely arranged, the third surface is a flat surface, and the fourth surface is the concave surface of the lens structure.

For example, according to an embodiment of the present disclosure, the phase retardation film is disposed between the second surface and the third surface, and the reflective polarizing layer is disposed on the fourth surface.

For example, according to an embodiment of the present disclosure, the lens structure includes a first lens and a second lens; the first lens has a first surface and a second surface that are oppositely arranged, the first surface is the convex surface of the lens structure, and the second surface is a curved surface; the second lens has a third surface and a fourth surface that are oppositely arranged, the third surface is a curved surface, and the fourth surface is the concave surface of the lens structure; and the second surface is consistent with the third surface in surface shape, an absolute value of a radius of curvature of the second surface in at least one direction is greater than an absolute value of a radius of curvature of the first surface, and an absolute value of a radius of curvature of the third surface in at least one direction is greater than an absolute value of a radius of curvature of the fourth surface.

For example, according to an embodiment of the present disclosure, absolute values of the radius of curvature of the second surface and the radius of curvature of the third surface are both greater than 100 millimeters.

For example, according to an embodiment of the present disclosure, the second surface has a curved surface with rotational symmetry or a curved surface with axial symmetry.

For example, according to an embodiment of the present disclosure, the phase retardation film is disposed between the second surface and the third surface, and the reflective polarizing layer is disposed on the fourth surface.

For example, according to an embodiment of the present disclosure, a ratio of a center thickness of the first lens to an edge thickness of the first lens is greater than or equal to 0.5 and less than 3; and a ratio of an edge thickness of the second lens to a center thickness of the second lens is greater than or equal to 0.5 and less than or equal to 2.

At least one embodiment of the present disclosure provides a display apparatus, including a display screen and the optical system according to any one of the above embodiments, where the display screen is located on a side of the convex surface of the lens structure away from the concave surface of the lens structure.

### BRIEF DESCRIPTION OF DRAWINGS

To illustrate the technical solutions of the embodiments of the present disclosure more clearly, the drawings for describing the embodiments are briefly described below. Apparently, the drawings in the following description show merely some embodiments of the present disclosure, and do not limit the present disclosure.

FIG. 1 is a schematic diagram of an optical system according to at least one embodiment of the present disclosure;

FIG. 2 is a simplified diagram of an optical path of the optical system according to at least one embodiment of the present disclosure;

FIG. 3 is a schematic diagram of an optical system according to at least another embodiment of the present disclosure;

FIG. 4 is a spot diagram of the optical system shown in FIG. 1;

FIG. 5 is a curve chart of a variation of a diffuse spot size with a field of view of the optical system shown in FIG. 1;

FIG. 6 is a distortion diagram of the optical system shown in FIG. 1;

FIG. 7 is a schematic diagram of an optical system according to at least yet another embodiment of the present disclosure; and

FIG. 8 is a schematic diagram of an optical system according to at least still another embodiment of the present disclosure.

### DETAILED DESCRIPTION

To make the objectives, technical solutions, and advantages of the embodiments of the present disclosure clearer, the technical solutions in the embodiments of the present disclosure will be described clearly and comprehensively with reference to the drawings in the embodiments of the present disclosure. Apparently, the described embodiments are some embodiments of the present disclosure, rather than all the embodiments. All other embodiments obtained by a person of ordinary skill in the art based on the embodiments of the present disclosure without creative efforts shall fall within the protection scope of the present disclosure.

Unless otherwise defined, the technical or scientific terms used in the present disclosure shall have general meanings as understood by a person of ordinary skill in the art to which the present disclosure belongs. “First”, “second”, and like words used in the present disclosure do not representany order, quantity, or importance, but are merely used to distinguish between different components. “Include” or “include” or like words mean that an element or item preceding the term encompasses an element or item or its equivalent listed after the term, without excluding other elements or items.

Features such as “perpendicular”, “parallel”, and “same” used in the embodiments of the present disclosure include features such as strict “perpendicular”, “parallel”, and “same”, and cases such as “substantially perpendicular”, “substantially parallel”, and “substantially the same” that include certain errors, and considering measurement and errors related to the measurement of a specific quantity (that is, limitations of a measurement system), mean within an acceptable deviation range for a specific value determined by a person of ordinary skill in the art. A “center” in the embodiments of the present disclosure may include a strict geometric center location and a substantially center location within a small area around the geometric center. For example, “substantially” may mean within one or more standard deviations, or within 10% or 5% of the value.

In a virtual reality device such as a head-mounted display apparatus, a folded-optical-path (pancake) technology is mostly used to reduce the volume of the virtual reality device, make its structure compact and thin, and create more space for the application of mobile wearable consumer electronic devices. A product using the folded-optical-path technology may include a single lens, two lenses, or a plurality of lenses. Combinations of different numbers of lenses may be separated from each other, that is, there is an air gap between the lenses, or the lenses may be glued to each other.

In research, the inventors of the present application have found that it is often difficult for an existing folded-optical-path product to meet requirements for optical parameters such as imaging clarity, afield of view, distortion, and chromatic aberration at the same time, affecting the user experience.

At least one embodiment of the present disclosure provides an optical system and a display apparatus. The optical system includes a lens structure, a reflective polarizing layer, a phase retardation film, and a transflective film. The lens structure includes a convex surface and a concave surface that are oppositely arranged, and a side of the concave surface away from the convex surface is a light exit side of the lens structure; the reflective polarizing layer is disposed on a side of the concave surface of the lens structure away from the convex surface of the lens structure; the phase retardation film is disposed on the side of the concave surface of the lens structure away from the convex surface of the lens structure; and the transflective film is disposed on a side of the convex surface away from the concave surface. A ratio of a radius of curvature of the convex surface to an effective focal length of the optical system is in a range from −1.2 to −2.5, and a ratio of a radius of curvature of the concave surface to the radius of curvature of the convex surface is in a range from 0.8 to 2; and in a direction parallel to an optical axis of the lens structure, a ratio of a center thickness of the lens structure to the effective focal length is in a range from 0.4 to 0.6.

The optical system provided by at least one embodiment of the present disclosure may be an optical system using a folded optical path (pancake). While the reflective polarizing layer, the phase retardation film, and the transflective film are disposed on two sides of the lens structure, parameters such as the radius of curvature of the concave surface and the convex surface of the lens structure and the center thickness of the lens structure are set and optimized, so that the optical system may be thinner and lighter, and at the same time, a larger full field of view may be achieved, and a larger eye relief and a smaller full image height may be obtained.

The optical system and the display apparatus are described below with reference to the drawings and some embodiments.

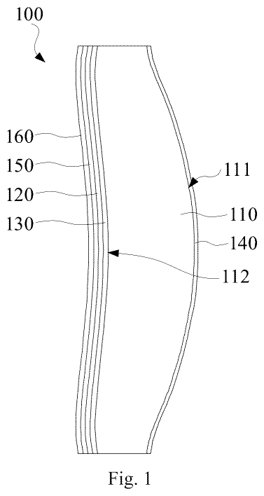

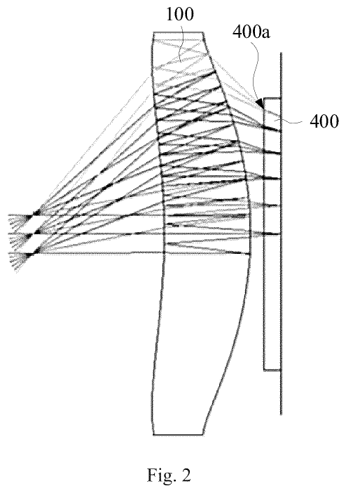

FIG. 1 is a schematic diagram of an optical system 100 according to at least one embodiment of the present disclosure, and FIG. 2 is a simplified diagram of an optical path of the optical system 100 according to at least one embodiment of the present disclosure.

Referring to FIG. 1 and FIG. 2, the optical system 100 includes a lens structure 110, a reflective polarizing layer 120, a phase retardation film 130, and a transflective film 140. The lens structure 110 includes a convex surface 111 and a concave surface 112 that are oppositely arranged, and a side of the concave surface 112 away from the convex surface 111 is a light exit side of the lens structure 110. For example, when the optical system 100 is applied to a display apparatus, a display screen 400 is located on a side of the convex surface 111 of the lens structure 110 away from the concave surface 112. Light emitted by the display screen 400 enters the lens structure 110 after passing through the convex surface 111, and then the light exits from the concave surface 112.

As shown in FIG. 1, the reflective polarizing layer 120 is disposed on the side of the concave surface 112 of the lens structure 110 away from the convex surface 111. For example, a polarizing reflective film has the following functions: there is a transmission axis direction in a film plane, a transmittance of a polarization component (such as s linearly polarized light) of incident light parallel to the transmission axis direction is greater than a transmittance of a polarization component (such as p linearly polarized light) of the incident light perpendicular to the transmission axis direction, and a reflectance of the polarization component (such as s linearly polarized light) parallel to the transmission axis direction is lower than a reflectance of the polarization component (such as p linearly polarized light) perpendicular to the transmission axis direction. For example, the reflective polarizing layer 120 may also be referred to as a polarizing beam-splitting film. For example, a transmittance of polarized light parallel to the transmission axis direction of the reflective polarizing layer 120 is not less than 85%, for example, not less than 90%, for example, not less than 95%, for example, not less than 98%; and a reflectance of polarized light perpendicular to the transmission axis direction of the reflective polarizing layer 120 is not less than 85%, for example, not less than 90%, for example, not less than 95%, for example, not less than 98%.

As shown in FIG. 1, the phase retardation film 130 is disposed on the side of the concave surface 112 of the lens structure 110 away from the convex surface 111. For example, the phase retardation film 130 is configured to enable the transmitted light to achieve a conversion between a circular polarization state and a linear polarization state. For example, the phase retardation film 130 may be a quarter-wave plate.

For example, the phase retardation film 130 has the following features: there are a direction with a lowest refractive index and a direction with a highest refractive index in a film plane, which are a fast axis and a slow axis respectively, and a phase of polarized light parallel to the slow axis after passing through the phase retardation film 130 lags behind a phase of polarized light parallel to the fast axis after passing through the phase retardation film 130 by a quarter of a wavelength.

For example, an angle between the slow axis of the phase retardation film 130 and the transmission axis of the polarizing reflective film is 45 degrees.

For example, a material of the phase retardation film 130 may include polycarbonate. The phase retardation film 130 made of the polycarbonate material is usually a flat film layer with a thickness of about 50 μm. When the phase retardation film 130 is attached to the concave surface 112 of the lens structure 110, the phase retardation film 130 made of the polycarbonate material may be appropriately stretched to fully fit the concave surface 112 in order to match the aspheric or free-form surface shape of the concave surface 112. Certainly, in combination with some embodiments described below, when the phase retardation film 130 is attached to a surface such as a flat surface or a cylindrical surface, it is not necessary to stretch the phase retardation film 130.

For example, the material of the phase retardation film 130 may include a liquid crystal polymer. Since the phase retardation film 130 made of the liquid crystal polymer material is a polymer, its film thickness is relatively thin and may reach 1 μm to 5 μm. The thinner phase retardation film 130 has a higher degree of adaptation to a curved surface, and may be more easily shaped according to the surface shape of the curved surface, reducing the possibility that wrinkles occur when the phase retardation film is attached to the curved surface, affecting the phase retardation accuracy and optical performance. Moreover, the optical deviation of the phase retardation film 130 made of the liquid crystal polymer material after being attached to the curved surface is smaller. The liquid crystal polymer is a cross-linked system in which molecules are connected by chemical bonds and which has a high modulus. In the case where the phase retardation film 130 made of this material is stretched after being attached, only elastic deformation occurs, and strong optical anisotropic effects such as molecular extension and rearrangement do not occur. Therefore, the phase retardation film 130 made of the liquid crystal polymer material is suitable for attaching to a surface shape with a small radius of curvature. Such a degree of freedom in the radius of curvature also makes it easier to meet the requirements for indicators such as clarity, distortion, and dispersion, which is favorable for the optical system 100 to obtain better image quality.

As shown in FIG. 1, the transflective film 140 is disposed on the side of the convex surface 111 away from the concave surface 112. For example, the transflective film 140 is configured to transmit part of light and reflect another part of light. For example, the transflective film 140 may have a transmittance of 50% and a reflectance of 50%. For example, the transflective film 140 may have a transmittance of 60% and a reflectance of 40%. For example, the transflective film 140 may have a transmittance of 65% and a reflectance of 35%. The optical system 100 provided in the present disclosure is not limited thereto, and the transmittance and reflectance of the transflective film 140 may be set according to product requirements. For example, the transflective film 140 may be coated on the convex surface 111.

For example, the reflective polarizing layer 120 is configured to reflect linearly polarized light of one characteristic and transmit linearly polarized light of another characteristic; the phase retardation film 130 is disposed on the side of the concave surface 112 away from the convex surface 111, and the reflective polarizing layer 120 is disposed on a side of the phase retardation film 130 away from the convex surface 111.

For example, as shown in FIG. 1 and FIG. 2, the reflective polarizing layer 120, the phase retardation film 130, and the transflective film 140 that are capable of reflecting linearly polarized light of one characteristic and transmitting linearly polarized light of another characteristic are used to form a folded optical path based on the following principle: a wave plate may be disposed on a display surface 400a side of the display screen 400 located on the side of the convex surface 111 away from the concave surface 112. Image light emitted from the display surface 400a is converted into right-handed circularly polarized light after passing through the wave plate, and a polarization state of the right-handed circularly polarized light is unchanged after the right-handed circularly polarized light is transmitted through the transflective film 140. The light enters the lens structure 110, reaches the phase retardation film 130 after being transmitted through the lens structure 110, and the right-handed circularly polarized light incident on the phase retardation film 130 is converted into p linearly polarized light. The p linearly polarized light is reflected by the reflective polarizing layer 120 back to the phase retardation film 130, where the first reflection occurs. Then, the p linearly polarized light is converted into right-handed circularly polarized light after passing through the phase retardation film 130. The right-handed circularly polarized light reaches the transflective film 140 after being transmitted through the lens structure 110, and is reflected at the transflective film 140, where the second reflection occurs. Due to a half-wave loss, the reflected light is changed from right-handed circularly polarized light to left-handed circularly polarized light. The left-handed circularly polarized light reaches the phase retardation film 130 after being transmitted through the lens structure 110, is changed into s linearly polarized light after passing through the phase retardation film 130, and then the s linearly polarized light is transmitted through the reflective polarizing layer 120 and then travels toward an exit pupil, such as a human eye.

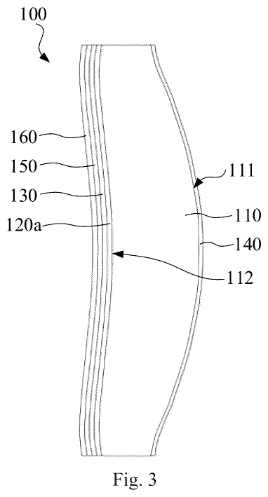

FIG. 3 is a schematic diagram of an optical system 100 according to at least another embodiment of the present disclosure. Referring to FIG. 3, for example, the reflective polarizing layer 120 is a cholesteric liquid crystal layer 120a. The cholesteric liquid crystal layer 120a is disposed on the side of the concave surface 112 away from the convex surface 111, and the phase retardation film 130 is disposed on a side of the cholesteric liquid crystal layer 120a away from the convex surface 111. Cholesteric liquid crystal is capable of reflecting and transmitting circularly polarized light. With reference to the principle of the folded optical path described above, the cholesteric liquid crystal layer 120a is disposed between the phase retardation film 130 and the concave surface 112 of the lens structure 110. Circularly polarized light is first reflected by the cholesteric liquid crystal layer 120a, transmitted through the lens structure 110 and reflected by the transflective film 140, then transmitted through the lens structure 110 and the cholesteric liquid crystal layer 120a, reaches the phase retardation film 130 and is changed into linearly polarized light, and then travels toward the exit pupil.

The folded optical path described above may change the polarization state of the light propagating between the reflective polarizing layer 120 and the transflective film 140, to achieve folding of the light. Thus, the effective focal length of the optical system 100, which would otherwise be increased by, for example, two reflections due to the provision of the reflective polarizing layer 120, the phase retardation film 130, and the transflective film 140, is folded, thereby greatly reducing the space required between the human eye and the optical system 100, and making the optical system 100 smaller, thinner, and lighter.

For example, as shown in FIG. 1, the optical system 100 further includes a linear polarizing film 150, and the linear polarizing film 150 is disposed on a side of the reflective polarizing layer 120 away from the transflective film 140. For example, a transmission axis of the linear polarizing film 150 is aligned with the transmission axis of the reflective polarizing layer 120. The linear polarizing film 150 is used to further filter other stray light, and only polarized light (such as s linearly polarized light) transmitted through the linear polarizing film 150 is allowed to enter the human eye. For example, a material of the linear polarizing film 150 may include polyvinyl alcohol (PVA) added with dichroic molecules, a liquid crystal polymer film added with dichroic molecules, or the like.

For example, the optical system 100 further includes an antireflective film 160, and the antireflective film 160 is disposed on a side of the linear polarizing film 150 away from the reflective polarizing layer 120. For example, the antireflective film 160 is favorable for reducing stray light caused by reflection.

For example, at least one of the convex surface 111 or the concave surface 112 is an aspheric surface or a free-form surface. The aspheric surface may be an even aspheric surface (EVENASPH), and a radius of curvature of the aspheric surface is a radius of curvature of a base spherical surface of the surface of the aspheric surface. The “base spherical surface” is a spherical surface that is further deformed on the basis of a spherical surface to form an aspheric surface, and the spherical surface that is the basis of the aspheric surface is the base spherical surface of the aspheric surface. The free-form surface is, for example, a complex unconventional continuous surface without a rotational symmetry axis.

For example, as shown in FIG. 1, a ratio of a radius of curvature of the convex surface 111 to an effective focal length of the optical system 100 is in a range from −1.2 to −2.5. The effective focal length isa distance from a rear principal image plane to a paraxial image plane. The effective focal length is, for example, an effective focal length of the surface of the lens structure 110 after coating. For example, the ratio of the radius of curvature of the convex surface 111 to the effective focal length of the optical system 100 is in a range from −1.4 to −2.3. For example, the ratio of the radius of curvature of the convex surface 111 to the effective focal length of the optical system 100 is in a range from −1.6 to −2.1. For example, the ratio of the radius of curvature of the convex surface 111 to the effective focal length of the optical system 100 is in a range from −1.8 to −1.9.

As shown in FIG. 1, a ratio of a radius of curvature of the concave surface 112 to the radius of curvature of the convex surface 111 is in a range from 0.8 to 2. For example, the ratio of the radius of curvature of the concave surface 112 to the radius of curvature of the convex surface 111 is in a range from 1.0 to 1.8. For example, the ratio of the radius of curvature of the concave surface 112 to the radius of curvature of the convex surface 111 is in a range from 1.2 to 1.6.

As shown in FIG. 1, an absolute value of a conic coefficient of the convex surface 111 is less than or equal to an absolute value of a conic coefficient of the concave surface 112. It may be understood that a degree of curvature of the convex surface 111 is greater than a degree of curvature of the concave surface 112, ensuring that the lens structure 110 is thicker at the center and thinner at the edge, and has a convex lens structure as a whole.

For example, the conic coefficient of the convex surface 111 is greater than or equal to −20 and less than 0. For example, the conic coefficient of the convex surface 111 may be, but is not limited to, −20,−18,−16,−14,−12,−10,−8,−6,−4,−2,−1,−0.5,−0.3, −0.1, etc. For example, the conic coefficient of the concave surface 112 is greater than or equal to −50 and less than or equal to the conic coefficient of the convex surface 111. For example, the conic coefficient of the concave surface 112 is less than or equal to the conic coefficient of the convex surface 111, and may be, but is not limited to, −50, −40, −30, −20, −10, −9, −7, −5, etc.

As shown in FIG. 1, in a direction parallel to an optical axis of the lens structure 110, a ratio of a center thickness of the lens structure 110 to the effective focal length is in a range from 0.4 to 0.6. The center thickness of the lens structure 110 refers to a dimension of the lens structure 110 intercepted by the optical axis thereof. For example, the center thickness is a distance between two points at which the optical axis of the lens structure 110 passes through the concave surface 112 and the convex surface 111. For example, the center thickness is a maximum thickness of the lens structure 110. For example, the ratio of the center thickness of the lens structure 110 to the effective focal length is in a range from 0.45 to 0.55. For example, the ratio of the center thickness of the lens structure 110 to the effective focal length is 0.5.

For example, a ratio of an effective aperture of the lens structure 110 to the effective focal length is greater than or equal to 2. The effective aperture of the lens structure 110 refers to a maximum aperture through which light may pass through the lens structure 110, and is determined by a maximum light flux of the lens structure 110. For example, the ratio of the effective aperture to the effective focal length is 2 to 2.75. It may be understood that the ratio may be, but is not limited to, 2, 2.25, 2.5, 2.75.

For example, a refractive index of the lens structure 110 is in a range from 1.45 to 1.75, and a larger refractive index is selected to facilitate obtaining of a larger radius of curvature. For example, the refractive index of the lens structure 110 is in a range from 1.5 to 1.7. For example, the refractive index of the lens structure 110 is in a range from 1.55 to 1.65. For example, the refractive index of the lens structure 110 is 1.6.

For example, a ratio of an optical total length of the optical system 100 to the effective focal length is in a range from 0.8 to 1.2. The optical total length refers to a distance from a highest point on the concave surface 112 of the lens structure 110 in the optical system 100 to a center of the display screen 400 along the optical axis. The highest point on the concave surface 112 includes an edge sag of the lens structure 110 on the concave surface 112 side. The ratio of the optical total length to the effective focal length may be, but is not limited to, 0.8, 0.9, 1.0, 1.1, 1.2.

For example, an Abbe number of the lens structure 110 is 30 to 60. For example, the Abbe number of the lens structure 110 may be, but is not limited to, 30, 35, 40, 45, 50, 55, 60.

For example, an eye relief of the optical system 100 is in a range from 12 to 18 millimeters. For example, the eye relief is a distance between the concave surface 112 and the exit pupil in an optical axis direction. The exit pupil is, for example, a human eye. For example, the eye relief may be, but is not limited to, 12 millimeters, 13 millimeters, 14 millimeters, 15 millimeters, 16 millimeters, 17 millimeters, 18 millimeters.

For example, a field of view of the optical system 100 is in a range from 900 to 110°. For example, the field of view is a full field of view. For example, the field of view of the optical system 100 may be, but is not limited to, 90°, 95°, 100°, 105°, 110°. For example, a binocular lens weight of about 20 g is obtained through calculation based on an effective aperture capable of achieving a field of view of 100°.

For example, a ratio of an image height of the optical system 100 to the effective aperture is in a range from 0.5 to 0.6. For example, the image height is a full image height. For example, the ratio of the image height to the effective aperture is 0.55.

In the optical system 100 provided in the present disclosure, while the lens structure 110 is matched with the folded optical path described above, one side of the lens structure 110 is set as the aspheric convex surface 111, and the other side is set as the aspheric concave surface 112. The effective focal length and the optical total length of the optical system 100 are set, and parameters such as the radii of curvature, the conic coefficients, the center thickness, and the effective aperture of the two aspheric surfaces of the lens structure 110 and the refractive index of the lens structure 110 are set, so that on the basis that the optical system 100 has a small size, the full field of view of the optical system 100 may reach in a range from 900 to 110°, and the eye relief may reach in a range from 12 to 18 millimeters, which is favorable for improving the user experience, for example, to satisfy a myopic user to use while wearing glasses.

For example, an aspheric surface shape is expressed by the following numerical formula:

$$z = \frac{{CY}^{2}}{1 + \sqrt{1 - ( 1 + k ) {C}^{2} {Y}^{2}}} + {\sum }_{i = 2}^{N} {α}_{i} {Y}^{2 i}$$

For example, in the above formula, a height of the aspheric surface in a direction perpendicular to the optical axis is Y, and a distance from an aspheric vertex to a projection of a position with the height of Y on the aspheric surface on the optical axis is z, that is, z is a coordinate in the optical axis direction; C is curvature (a reciprocal of the radius of curvature R), k is a conic coefficient (Coin Constant), α₁ is a coefficient of each high-order term, and 2i is a high order of the aspheric surface (the order of Aspherical Coefficient).

In actual optimization of a reasonable configuration of each parameter of the lens structure 110, values such as the radius of curvature, the conic coefficient, the height, and the aspheric coefficient of the lens structure 110 are substituted into the numerical formula described above, and optical simulation calculation is performed to obtain each optimization parameter capable of correcting aberration of the lens structure 110. Preferred values of the radius of curvature, the thickness along the optical axis, the effective aperture, and the conic coefficient of the lens structure 110 are obtained through the optimization process.

For example, coefficients of high-order terms of the convex surface 111 and the concave surface 112 are shown in Table 1.

| | a4 | a6 | a8 |
|---|---|---|---|
| Convex surface | −4.0174e−5 | 2.5787e−7 | −1.6641e−9 |
| Concave surface | 2.0173e−5 | −1.2634e−7 | 5.2608e−10 |

For example, the lens structure 110 is an integral lens, and the convex surface 111 and the concave surface 112 are located on two opposite sides of the integral lens. For example, the integral lens may be referred to as a single lens. For example, the integral lens may be a convex lens.

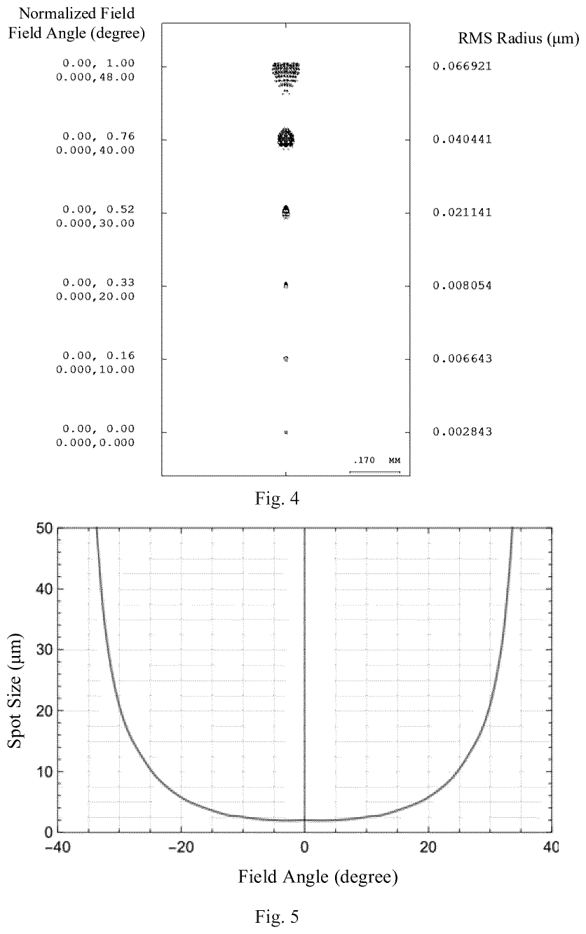

FIG. 4 is a spot diagram of the optical system 100 shown in FIG. 1. The spot diagram refers to a dispersion pattern in which many light rays emitted from a point no longer converge at the same point but are scattered in a certain range due to aberration after passing through the optical system 100, and may be used to evaluate the imaging quality of the optical system 100. In FIG. 4, taking the first group of values in the left longitudinal direction as an example, 0.00 represents a normalized field of view in the X direction, 1.00 represents a normalized field of view in the Y direction, 0.000 represents a field angle in the X direction, and 48.00 represents a field angle in the Y direction. FIG. 4 is usually used to evaluate the full-field clarity of the optical system, that is, when the pupil of the human eye is at the entrance pupil position on the optical axis and gazing at the center of the lens (that is, zero field of view), the imaging clarity of the full-field range that can be covered by the remaining light, which is also referred to as the transient mode. In addition to the full-field clarity in the transient mode, for example, for a wearer wearing a head-mounted display, the clarity of the gaze point is one of the more important optical indicators. The clarity of the gaze point refers to the clarity of images in a certain angular range that can be directly seen (rather than seen from the remaining light) when the eyes turn up, down, left, and right. In the gaze point mode, the eyeball rotates by a certain angle, the pupil deviates from the center of the optical axis, the pupil has a certain deviation from the optical axis in the Z direction and the Y direction, and the chief ray passing through the center of the pupil has a certain angle with the Z axis. For example, the range of the angle is ±35 degrees. The range of the angle is set considering the observation habit of the human eyes. To see an object in front that is beyond the range of 35 degrees from the center of the human eyes, a person turns the head actively rather than rotates the eyeball with effort. Referring to FIG. 5, FIG. 5 shows the relationship between the clarity of the gaze point and the gaze angle. The dispersion spot in the central field of view is much smaller than one pixel, and the dispersion spot diameter is 10 microns when the human eyes turn to 25 degrees. It may be seen from FIG. 5 that the dispersion spot of the optical system of the present application is small, and the resolution of the optical system is high. In conclusion, it may be seen that the optical system 100 provided by at least one embodiment of the present disclosure may form a clear image.

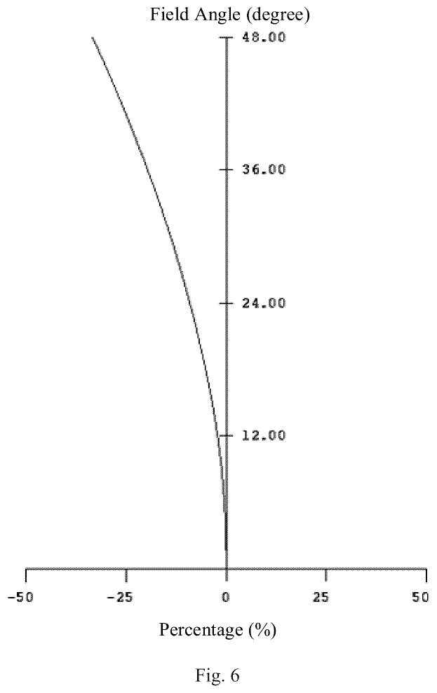

FIG. 6 is a distortion diagram of the optical system 100 shown in FIG. 1. The distortion diagram reflects the image plane position difference of clear images formed in different fields of view. As shown in FIG. 6, the maximum absolute value of distortion is within 50%. It may be seen that the optical system 100 provided by at least one embodiment of the present disclosure may better correct the distortion to meet the requirement for high-quality imaging. In addition, distortion correction may be pre-processed in software.

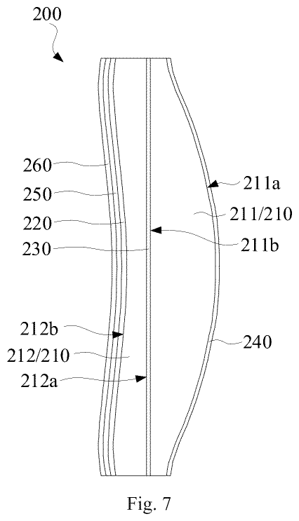

FIG. 7 is a schematic diagram of an optical system 200 according to at least another embodiment of the present disclosure. Referring to FIG. 7, for example, the lens structure 210 includes a first lens 211 and a second lens 212; the first lens 211 has a first surface 211a and a second surface 211b that are oppositely arranged, the first surface 211a is the convex surface of the lens structure 210, and the second surface 211b is a flat surface; and the second lens 212 has a third surface 212a and a fourth surface 212b that are oppositely arranged, the third surface 212a is a flat surface, and the fourth surface 212b is the concave surface of the lens structure 210. For example, the first surface 211a is curved in a direction away from the flat surface to form the convex surface of the lens structure 210. For example, the fourth surface 212b is curved in a direction close to the flat surface to form the concave surface. For example, the second surface 211b and the third surface 212a are glued together. However, the present solution is not limited thereto, and for example, there may be an air gap between the second surface 211b and the third surface 212a, thereby increasing the degree of freedom in designing the optical system. In the lens structure 210 including the first lens 211 and the second lens 212, the thickness of a single lens is reduced, which may reduce the processing difficulty.

For example, as shown in FIG. 7, the first lens 211 may be a plano-convex lens, and the second lens 212 may be a plano-concave lens.

The first surface and the fourth surface in the lens structure provided in this example may have the same surface shape features as the convex surface and the concave surface in the lens structure shown in FIG. 1, and details are not described herein again.

For example, the first lens 211 and the second lens 212 may be made of different optical materials, so that the first lens 211 and the second lens 212 have different abbe numbers, thereby compensating for dispersion. For example, a material of the first lens 211 is polystyrene (PS) with a refractive index of 1.59 and an abbe number of 30.8, and a material of the second lens 212 is optical-grade polymethyl methacrylate (PMMA) with a refractive index of 1.49 and an abbe number of 57.2. For example, a material of the first lens 211 is polycarbonate (PC) with a refractive index of 1.58 and an abbe number of 34, and a material of the second lens 212 is optical-grade polymethyl methacrylate (PMMA) with a refractive index of 1.49 and an abbe number of 57.2.

For example, the first lens 211 and the second lens 212 may also be made of the same optical material. In the case where the first lens 211 and the second lens 212 are made of the same optical material, optical characteristics such as spectral transmittance, refractive index, and abbe number may be considered, and processability such as fluidity, heat shrinkage, stress, and cost of the material may also be considered. For example, materials such as optical-grade polymethyl methacrylate (PMMA), polycarbonate (PC), cyclic olefin copolymer (COC), cyclic olefin homopolymer (COP), and polyethylene terephthalate (PET) may be used.

For example, the phase retardation film 230 is disposed between the second surface 211b and the third surface 212a, and the reflective polarizing layer 220 is disposed on the fourth surface 212b. Since the second surface 211b and the third surface 212a are both flat surfaces, disposing the phase retardation film 230 on the flat surface may reduce the difficulty in attaching and meet the requirements for indicators such as clarity, distortion, and color cast.

The reflective polarizing layer, the transflective film, and the linear polarizing film in the optical structure provided in this example may have the same features as the reflective polarizing layer, the transflective film, and the linear polarizing film in the optical structure shown in FIG. 1, and details are not described herein again.

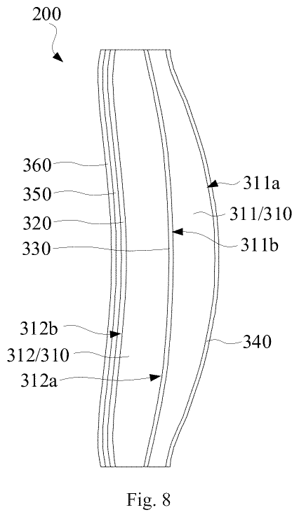

FIG. 8 is a schematic diagram of an optical system 300 according to at least another embodiment of the present disclosure. For example, the lens structure 310 includes a first lens 311 and a second lens 312; the first lens 311 has a first surface 311a and a second surface 311b that are oppositely arranged, the first surface 311a is the convex surface of the lens structure 310, and the second surface 311b is a curved surface; the second lens 312 has a third surface 312a and a fourth surface 312b that are oppositely arranged, the third surface 312a is a curved surface, and the fourth surface 312b is the concave surface of the lens structure 310; and the second surface 311b is consistent with the third surface 312a in surface shape. The surface shapes being consistent means that the second surface 311b and the third surface 312a may be fully attached to each other. Certainly, the second surface 311b and the third surface 312a may be glued together or may have an air gap.

The first surface and the fourth surface in the lens structure provided in this example may have the same surface shape features as the convex surface and the concave surface in the lens structure shown in FIG. 1, and details are not described herein again.

For example, an absolute value of a radius of curvature of the second surface 311b is greater than an absolute value of a radius of curvature of the first surface 311a, and an absolute value of a radius of curvature of the third surface 312a is greater than an absolute value of a radius of curvature of the fourth surface 312b. By making the second surface 311b and the third surface 312a as curved surfaces, it is easy to adjust the center thickness and the edge thickness of the first lens 311 and the second lens 312, thereby reducing the processing difficulty.

For example, the second surface 311b is a concave surface curved toward the first surface 311a, so that the difference between the center thickness and the edge thickness of the first lens 311 is small. For example, the third surface 312a is a convex surface curved away from the fourth surface 312b, so that the difference between the center thickness and the edge thickness of the second lens 312 is small.

For example, absolute values of the radius of curvature of the second surface 311b and the radius of curvature of the third surface 312a are both greater than 100 millimeters. The radius of curvature of the second surface 311b and the radius of curvature of the third surface 312a are set to be large, that is, the second surface 311b and the third surface 312a are configured as micro-curved surfaces close to flat surfaces. For example, the radius of curvature of the second surface 311b and the radius of curvature of the third surface 312a are both less than −100 millimeters.

For example, the second surface 311b is a curved surface with rotational symmetry or a curved surface with axial symmetry. The curved surface with rotational symmetry refers to a curved surface formed by a curve rotating around a straight line for one week, the plane curve is a generatrix of the rotational curved surface, and the straight line is a rotation axis of the rotational curved surface. The curved surface with rotational symmetry has the same radius of curvature and conic coefficient in different directions. The curved surface with axial symmetry means that the curved surface may be symmetrical along an axis of symmetry, for example, the curved surface has different radii of curvature or conic coefficients in different directions. For example, the curved surface with axial symmetry may be a cylindrical surface, and the cylindrical surface refers to a curved surface formed by a straight line moving parallel along a fixed curve. When the curved surface is a cylindrical surface, the curved surface is a curved surface in one direction and a flat surface in another direction.

For example, the phase retardation film 330 is disposed between the second surface 311b and the third surface 312a, and the reflective polarizing layer 320 is disposed on the fourth surface 312b. In this way, the second surface 311b and the third surface 312a have a large radius of curvature, which may provide a better attaching surface shape for the phase retardation film 330 and reduce the attaching difficulty.

For example, a ratio of a center thickness of the first lens 311 to an edge thickness of the first lens 311 is greater than or equal to 0.5 and less than or equal to 3. For example, the ratio of the center thickness of the first lens 311 to the edge thickness of the first lens 311 is 2.9, 2.7, 2.5, 2.3, 2, 1.5, 1, 0.7, 0.5. In this way, injection molding of the first lens 311 may be ensured through a more reasonable ratio.

For example, a ratio of an edge thickness of the second lens 312 to a center thickness of the second lens 312 is greater than or equal to 0.5 and less than or equal to 2. For example, the ratio of the edge thickness of the second lens 312 to the center thickness of the second lens 312 is 2, 1.8, 1.6, 1.4, 1.2, 1, 0.8, 0.5. In this way, injection molding of the second lens 312 may be ensured through a more reasonable ratio.

The reflective polarizing layer, the transflective film, and the linear polarizing film in the optical structure provided in this example may have the same features as the reflective polarizing layer, the transflective film, and the linear polarizing film in the optical structure shown in FIG. 1, and details are not described herein again.

Referring to FIG. 2, at least one embodiment of the present disclosure provides a display apparatus, including a display screen 400 and the optical system 100 according to any one of the above embodiments. The display screen 400 is located on a side of the convex surface 111 of the lens structure 110 away from the concave surface 112. Since the display apparatus according to the embodiment of the present disclosure includes at least one optical system 100 described above, it also has corresponding beneficial technical effects, which are not described herein again.

For example, a display surface 400a of the display screen 400 is located on a focal plane on an entrance side of the optical system 100.

For example, the display screen 400 may be any type of display screen, such as a liquid crystal display screen, an organic light emitting diode display screen, an inorganic light emitting diode display screen, a quantum dot display screen, a projector (such as an LCOS pico projector), etc.

For example, the display screen is a liquid crystal display screen with a pixel size of about twenty-odd microns. For example, the display screen is an organic light emitting diode display screen with a pixel size of about several microns.

For example, the display apparatus may be a virtual reality display apparatus. For example, the virtual reality display apparatus may be a display apparatus using an ultra-short-throw folded optical path.

For example, the display apparatus may be a near-eye display apparatus, and the near-eye display apparatus may be a wearable VR headset, VR glasses, etc., which is not limited to the embodiments of the present disclosure.

The following several points need to be noted:
(1) In the drawings of the embodiments of the present disclosure, only the structures related to the embodiments of the present disclosure are involved, and for other structures, reference may be made to general designs.
(2) Features in the same embodiment or different embodiments of the present disclosure may be combined with each other without conflict.

The above description is only exemplary implementations of the present disclosure, and is not intended to limit the protection scope of the present disclosure. The protection scope of the present disclosure is defined by the appended claims.

1. An optical system, comprising:
a lens structure, comprising a convex surface and a concave surface that are oppositely arranged, wherein a side of the concave surface away from the convex surface is a light exit side of the lens structure;
a reflective polarizing layer, disposed on the side of the concave surface of the lens structure away from the convex surface of the lens structure;
a phase retardation film, disposed on the side of the concave surface of the lens structure away from the convex surface of the lens structure; and
a transflective film, disposed on a side of the convex surface away from the concave surface,
wherein a ratio of a radius of curvature of the convex surface to an effective focal length of the optical system is in a range from −1.2 to −2.5, and a ratio of a radius of curvature of the concave surface to the radius of curvature of the convex surface is in a range from 0.8 to 2; and in a direction parallel to an optical axis of the lens structure, a ratio of a center thickness of the lens structure to the effective focal length is in a range from 0.4 to 0.6.

2. The optical system of claim 1, wherein an absolute value of a conic coefficient of the convex surface is less than or equal to an absolute value of a conic coefficient of the concave surface.

3. The optical system of claim 2, wherein the conic coefficient of the convex surface is greater than or equal to −20 and less than 0, and the conic coefficient of the concave surface is greater than or equal to −50 and less than or equal to the conic coefficient of the convex surface.

4. The optical system of claim 1, wherein at least one selected from the group consisting of the convex surface or the concave surface is an aspheric surface or a free-form surface.

5. The optical system of claim 1, wherein a ratio of an optical total length of the optical system to the effective focal length is in a range from 0.8 to 1.2.

6. The optical system of claim 1, wherein a ratio of an effective aperture of the lens structure to the effective focal length is greater than or equal to 2.

7. The optical system of claim 1, wherein an eye relief of the optical system is in a range from 12 millimeter to 18 millimeter.

8. The optical system of claim 1, wherein a field of view of the optical system is in a range from 900 to 110°.

9. The optical system of claim 1, wherein the lens structure is an integral lens, and the convex surface and the concave surface are located on opposite sides of the integral lens.

10. The optical system of claim 1, wherein the reflective polarizing layer is configured to reflect linearly polarized light of one characteristic and transmit linearly polarized light of another characteristic; the phase retardation film is disposed on the side of the concave surface away from the convex surface, and the reflective polarizing layer is disposed on a side of the phase retardation film away from the convex surface; or
the reflective polarizing layer is a cholesteric liquid crystal layer; and the cholesteric liquid crystal layer is disposed on the side of the concave surface away from the convex surface, and the phase retardation film is disposed on a side of the cholesteric liquid crystal layer away from the convex surface.

11. The optical system of claim 10, wherein the optical system further comprises a linear polarizing film; and
the linear polarizing film is disposed on a side of the reflective polarizing layer away from the transflective film.

12. The optical system of claim 1, wherein the lens structure comprises a first lens and a second lens;
the first lens has a first surface and a second surface that are oppositely arranged, the first surface is the convex surface of the lens structure, and the second surface is a flat surface; and
the second lens has a third surface and a fourth surface that are oppositely arranged, the third surface isa flat surface, and the fourth surface is the concave surface of the lens structure.

13. The optical system of claim 12, wherein the phase retardation film is disposed between the second surface and the third surface, and the reflective polarizing layer is disposed on the fourth surface.

14. The optical system of claim 1, wherein the lens structure comprises a first lens and a second lens;
the first lens has a first surface and a second surface that are oppositely arranged, the first surface is the convex surface of the lens structure, and the second surface is a curved surface;
the second lens has a third surface and a fourth surface that are oppositely arranged, the third surface isa curved surface, and the fourth surface is the concave surface of the lens structure; and
the second surface is consistent with the third surface in surface shape, an absolute value of a radius of curvature of the second surface in at least one direction is greater than an absolute value of a radius of curvature of the first surface, and an absolute value of a radius of curvature of the third surface in at least one direction is greater than an absolute value of a radius of curvature of the fourth surface.

15. The optical system of claim 14, wherein absolute values of the radius of curvature of the second surface and the radius of curvature of the third surface are both greater than 100 millimeters.

16. The optical system of claim 14, wherein the second surface is a curved surface with rotational symmetry or a curved surface with axial symmetry.

17. The optical system of claim 14, wherein the phase retardation film is disposed between the second surface and the third surface, and the reflective polarizing layer is disposed on the fourth surface.

18. The optical system of claim 14, wherein a ratio of a center thickness of the first lens to an edge thickness of the first lens is greater than or equal to 0.5 and less than 3; and
a ratio of an edge thickness of the second lens to a center thickness of the second lens is greater than or equal to 0.5 and less than or equal to 2.

19. A display apparatus, comprising a display screen and an optical system, wherein the display screen is located on the side of the convex surface of the lens structure away from the concave surface of the lens structure,
wherein the optical system comprises:
a lens structure, comprising a convex surface and a concave surface that are oppositely arranged, wherein a side of the concave surface away from the convex surface is a light exit side of the lens structure;
a reflective polarizing layer, disposed on the side of the concave surface of the lens structure away from the convex surface of the lens structure;
a phase retardation film, disposed on the side of the concave surface of the lens structure away from the convex surface of the lens structure; and
a transflective film, disposed on a side of the convex surface away from the concave surface,
wherein a ratio of a radius of curvature of the convex surface to an effective focal length of the optical system is in a range from −1.2 to −2.5, and a ratio of a radius of curvature of the concave surface to the radius of curvature of the convex surface is in a range from 0.8 to 2; and in a direction parallel to an optical axis of the lens structure, a ratio of a center thickness of the lens structure to the effective focal length is in a range from 0.4 to 0.6.

20. The display apparatus of claim 19, wherein an absolute value of a conic coefficient of the convex surface is less than or equal to an absolute value of a conic coefficient of the concave surface.
